(19) United States
(12) Patent Application Publication
(10) Pub. No.: US 2006/0288335 A1
(43) Pub. Date: Dec. 21, 2006

(54) Optimizing instructions for execution on parallel architectures

(76) Inventors: Stephen D. Goglin, Hillsboro, OR (US); Erik J. Johnson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/156,096

(22) Filed: Jun. 17, 2005

(51) Int. Cl. G06F 9/44

(52) U.S. Cl. 717/130

(57) ABSTRACT

Instructions may be optimized for execution on parallel architectures. In one embodiment, the invention includes parsing a code sequence into an internal representation of the sequence, finding an input channel in the internal representation, finding a put to the input channel in the internal representation, finding a get to the input channel in the internal representation, replacing the input channel with a temporary variable, replacing the put with a first function call to the temporary variable, and replacing the get with a second function call to the temporary variable. Other embodiments are described and claimed.

### BACKGROUND

1. Field

The present description relates to pre-processing instruction sequences for parallel execution, and in particular to optimizing the pre-processing to reduce overhead caused by passing messages.

2. Related Art

Many applications which can benefit from parallel hardware, such as multiple processors, multiple cores in one processor and multiple systems clustered together are described using a data-flow, or message passing model. A data flow model allows the individual stages in the data-flow model to execute in parallel. However, processing resources are consumed by the overhead of passing information between the stages of the model.

In systems that are used for developing data-flow applications, the programmer describes the application as a set of actors, each actor works on a separate stage of the application. The stages are connected together through some form of message passing construct, such as a channel or a queue.

Data is sent from one stage of the application to the next through the channels. By breaking the application into multiple stages, the application can be parallelized by allowing each stage to be working on different data concurrently. Each stage can also be duplicated to further increase parallelism.

In such a data flow model using actors, the overhead of passing data or messages between the actors comes in part from the queuing constructs typically used to represent the channels. These queuing constructs are often implemented in memory. As a result, message passing results in extra memory references.

Pre-processing models, such as compilers attempt to optimize the process flow and reduce the overhead of passing messages between the actors. One proposed compiler optimization is to co-locate actors onto the same processor and eliminate the queuing construct for such co-located actors. This limits possible parallel operations. Other compiler optimizations try to optimize out the message passing overhead but cannot be applied when the communications are explicit in the source code.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of a process flow between actors in a message passing application;

FIG. 2 is a process flow diagram of pre-processing a data flow program according to an embodiment of the invention; and

FIG. 3 is a block diagram of a computer system suitable for use with the present invention.

### DETAILED DESCRIPTION

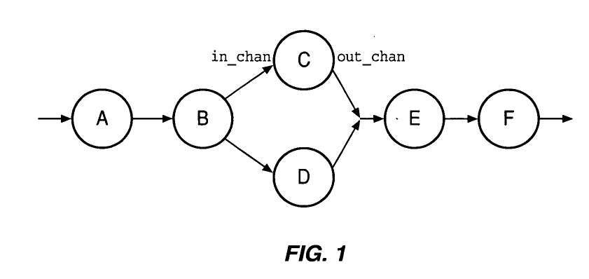

FIG. 1 shows a diagram of a data-flow application with six actors. The data flow application may be in the form of a sequence of instructions, such as a code sequence or programming code or in a variety of other forms. In the example of FIG. 1, the illustrated data flow may be invoked by program source code or by compiled machine language code or both. The application comes first to actor A, which passes it to actor B using a message passing channel. The channel may be thought of as a reliable, unidirectional, typed conduit for passing information between one or more source endpoints and a sink endpoint. For the message passing channel, there is an in channel and an out channel endpoint. From actor B the data flow is divided into two message channels between actors B and C, and D. From actors C and D, the data-flow application combines into a single message channel to flow into actor E and from actor E to actor F another message channel is used. The actors execute processes on the data flow and pass the results down the chain as shown from left to right. The actors may be embodied by processing threads, processing cores, microprocessors, controllers, system processing clusters or other processing entities.

A compiler may remove some of the message passing overhead without changing the semantics of the program. Specifically, under certain circumstances, some of the message passing constructs may be implemented with function calls rather than with queues. This can allow the execution of certain applications to be optimized on large-scale multiprocessor or chip multiprocessor systems. According to one embodiment of the invention, a compiler may automatically determine when it is safe to replace an active channel, with a function call, and how it can be done. In such an embodiment, an active channel may be considered to be a channel explicitly referenced by the channel's consuming actor. While embodiments of the present invention are presented in the context of optimizing a compilation of source code for parallel execution, embodiments of the invention may be applied to any automated form of transforming one work into another work.

With current compilers it has only been possible to co-locate actors in which the message passing “get”, or retrieve, constructs are implicit in the application. For example, the following paragraph illustrates an implicit “get” operation using pseudo code for the data-flow actor “C” show in FIG. 1.

/* Implicit channel “get” operation */
void C::service_function(data *d) {

workon(d);
channel_put(out_chan, d); /* pass data on to next stage */

}

In the above paragraph, the data, d, arriving from actor B at actor C implicitly appears when the actor C is invoked. By co-locating B and C, no queuing is required and the corresponding overhead and memory accesses are eliminated.

In the paragraph below, the actor C is written with an explicit get operation.

/* Explicit channel “get” operation */
void C::service_function( ) {

data *d;
do_some_work( );
d = channel_get(d);
workon(d);
channel_put(out_chan, d); /* pass data on to next stage */

}

In the above paragraph, C explicitly requests data, d. In this case, the actors B and C cannot be co-located and the overhead from the get and the corresponding put that puts d on the channel cannot be eliminated.

However, according to an embodiment of the present invention, even with explicit get operations, the active channel between the two actors may be replaced with a function call. In one example, the code for an actor is explicitly, or actively, seeking out new data to work on from one or more input channels. This may occur for actors that periodically poll their input channels for data.

When two actors communicating via an active channel are co-located for execution, the active channel of the two co-located actors may safely be replaced with a function call without changing the semantics of the original code. The replacement may be done even if the second of the two co-located actors is actively requesting data rather than passively, or implicitly, receiving the data.

For example, according to an embodiment of the invention, a channel between actors E and F as shown in FIG. 1 could be replaced with a function as illustrated by the pseudo code shown in the following two examples

Example 1, explicit request for active channel data:

void #::service_function( ) {

data *d;
d = channel_get(e_in); /* get data */
workon(d);
channel_put(e_out, d); /* pass data on to next stage */

}
Void F::service_{—function( ) {}

data *d;
do_some_work( );
d = channel_get(f_in);
if (!somequestion(d))

return; /* don't always have to pass on data */

else

channel_put(f_out,d);

}

Example 2, active channel replaced by temporary variable

void E::hidden_service_function( ) {

data *d;
d = channel_get(e_in); /* get data */
workon(d);
temp_var_out = d; /* pass data on to next stage */

}
void F::combined_service_function( ) {

data *d;
do_some_work( );
E::hidden_service_function( );
d = E::temp_var_out;
if (!somequestion(d))

return; /* don't always have to pass on data */

else

channel_put(bar,d);

}

In the second example, the compiler's optimizer has replaced the channel put with an assignment to a temporary variable that may be seen by both stages. It has also replaced the channel get with a call to the previous stage's service function, and has assigned the temporary variable to be the variable that was set to the result of the get. As a result of the replacement, a runtime system, or a compiler, is likely to schedule only F's service function and no queue is necessary. With the original compilation of Example 1, E and F would likely be scheduled when the channel is transformed into a queue.

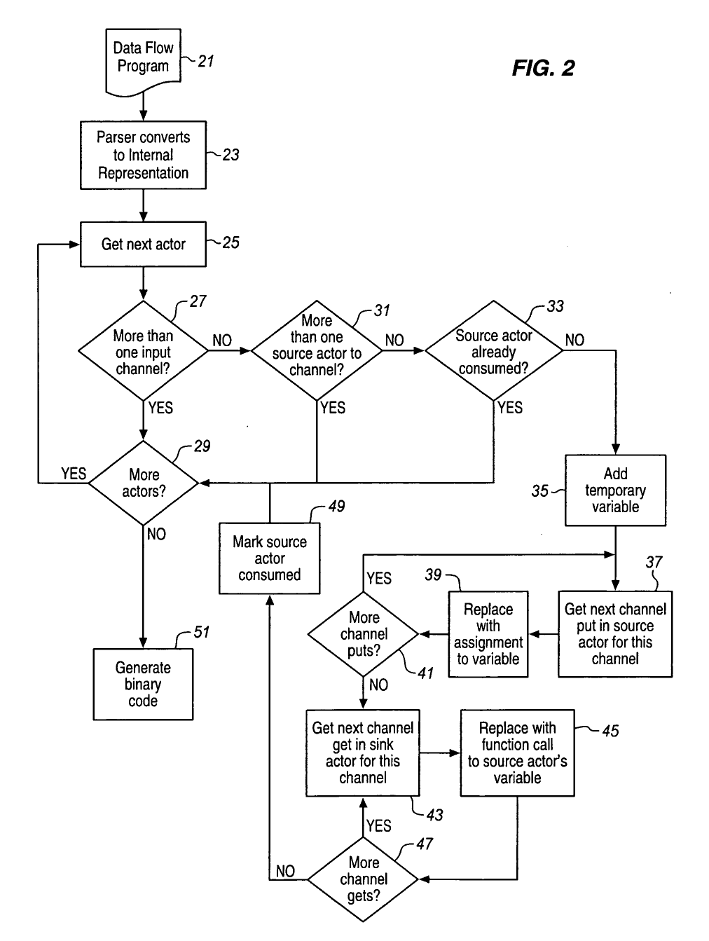

FIG. 2 provides an example of determining when it may be safe to replace a channel get with a function call according to an embodiment of the invention. The example of FIG. 2 applies to two actors communicating via an active channel and which are co-located. The actor that puts data onto a channel is called the source actor, and the actor that gets data off of the channel is called the sink actor.

In the example of FIG. 2, a data flow program of some type is presented at block 21. The data flow program may already be compiled and then presented for optimization, or it may not yet be compiled. A parser then converts the data flow program into an internal representation that may be used in the following blocks at block 23. The internal representation is searched for an actor at block 25. The actors, as mentioned above, may be represented in any of a variety of different ways and may constitute threads of a hyper or multi-threading system, a pipeline in a pipelining system or a subroutine, for example. Having found an actor, the process may begin to optimize the data flow.

The data flow of the internal representation is subjected to a set of tests as shown in blocks 27, 31, and 33. More or fewer or different tests may be used depending on the particular implementation. In addition, the tests may be performed in a variety of different orders other than the one shown here. The first test is to determine whether the actor has more than one active input channel or queue at block 27. The actor in the present example is a source actor that may be putting data on an active channel. If there is more than one active channel to which the source actor puts data, then the replacement may not be made and the process returns to determine whether there are other actors to evaluate at block 29. For actors that have more than one active channel, it may be possible for a function call to block a channel put or a channel get. In order to avoid starving any of the channels, none of the channels are replaced with a temporary variable.

If the actor passes the first test at block 27, then it is passed to the next test shown in FIG. 2 at block 31. This test determines whether more than one source actor uses the same active channel that is being used by the current source actor. If another actor may also put data to the same channel then no replacement is made and the process returns to consider the next actor, if any, at block 29. It is possible that a function call by one actor may block a function call by another actor and again, to avoid starving the channel, no replacement is made.

If the active channel is used by only one source actor, then the process continues to the next test at block 33. In this test, it is determined whether the actor is already consumed. After an active channel has been replaced with a temporary variable, the actor that puts data on that channel is marked as consumed, as shown at block 49. The test at block 33 determines whether the actor already has a function call to a temporary variable. If so, then adding additional function calls to additional temporary variables may make the scheduling too complicated for the data flow program to handle. Again, actors may be starved, i.e. may not be able to access the data when needed, as a result. If the actor is already consumed, then the process returns to find more actors at block 29.

If the actor is not consumed and all of the tests are passed, then the output channel for that actor may be replaced with a function call to a temporary variable. In the example of FIG. 2, a temporary variable is added to the internal representation at block 35. At block 37, a channel put from the source actor is retrieved and at block 39, this channel put is replaced with an assignment to a variable. Due to this replacement, the source actor, instead of putting data to an active channel, will assign the data to the temporary variable, avoiding the overhead of an active channel or queue.

At block 41, a check is made to determine if there are any more channel puts from this source actor. If so, then the process returns to block 37 to find the puts and convert them to variable assignments. When there are no more channel puts from this source actor, then the activity on this channel from sink actors is investigated.

At block 43, a channel get function call from the same active channel by a sink actor is found. At block 45 the channel get is replaced with a function call to the source actor's service function and the source actor's assignment to the temporary variable. At block 47, it is determined whether there are any other sink actor channel gets for this active channel. If there are, then the process returns to block 43 to identify these gets and make a replacement. If there are no more channel gets, then the process proceeds to block 49.

At block 49, the source actor for which the replacement was made is marked as consumed. This marking is used in the initial test indicated at block 33. By marking the actor as consumed, function call conflicts may be avoided, as mentioned above. The sink actors are not marked as consumed. Having marked the source actor, the process returns to operate on the remaining actors at block 29. If there are no more actors, then the optimization of FIG. 2 may be concluded. The internal representation, as modified, may be passed onto other processes or a binary code may be generated at block 51.

The diagram of FIG. 2 may be represented as pseudo code as shown by the following example. The operation of the pseudo code is about the same as is shown in the diagram and so will not be described separately.

For each a

If a has more than one input channel, then do not replace any active

channels.

Go to next a

For each c in input channels of a

If c has more than one actor hooked to its input, then do not

replace any input channels.

Go to next a

Let b be other actor connected to input of c

If b has already been marked as consumed, do not replace the input

channel.

Mark b as consumed
Replace all occurrences of channel_put to c in actor b with an

assignment to a global, temporary variable

Replace all occurrences of channel_get from c in actor a with a call

to b's service function and an assignment from the temporary variable

The optimization process of FIG. 2, may be applied to a wide variety of different compiling operations, for example a chip-multiprocessor compiler designed for a multi-core processor architecture. Multi-core processor architectures are currently intended for use with network applications and may be then applied to other applications including desktop and portable applications. A great variety of different applications including those that can be represented in a data-flow model may benefit from the optimization described above. Such applications may include networking, signal processing, and graphic processing, among others.

As can be understood from the description above and from FIG. 2, embodiments of the present invention may be applied to any data-flow language or compiler that supports active channels. The resulting binary code may have a reduction in or complete lack of queuing constructs and an improved order of execution of the actors. In many cases, a downstream actor's code may run all the way up to the channel read before any upstream actor's code executes.

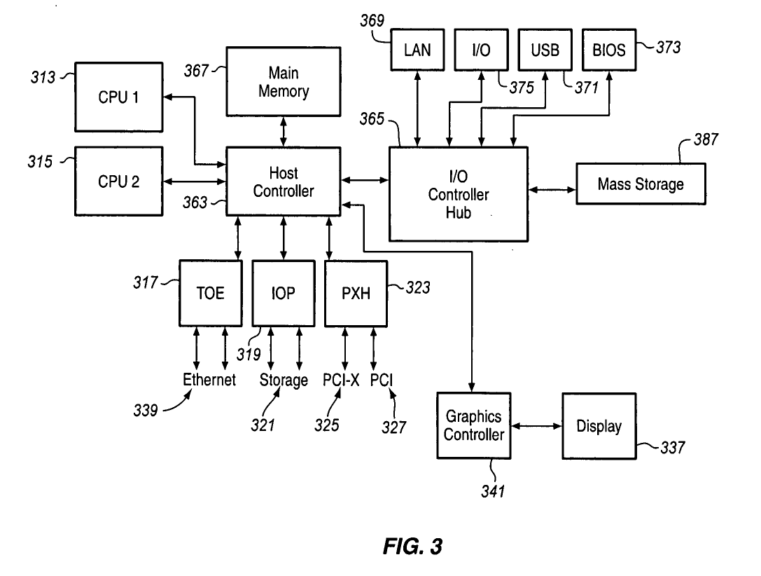

FIG. 3 provides an example of a computer system that may be used to apply the optimization mentioned above using a compiler. It also represents an example of a computer system on which the resulting binary code may executed. In the example system of FIG. 9, an MCH (Memory Controller Hub) 311 has a pair of FSBs (front side bus) each coupled to a CPU or processor core 313, 315. More or less than two processors, processor cores and FSBs may be used. Any number of different CPUs and chipsets may be used. The north bridge receives and fulfills read, write and fetch instructions from the processor cores over the FSBs. The north bridge also has an interface to system memory 367, in which instructions and data may be stored, and an interface to an ICH (Input/output Controller Hub) 365. Any one or more of the CPUs, MCH, and ICH may be combined. Alternatively, each CPU may include an MCH or ICH or both.

The MCH may also have an interface, such as a PCI (peripheral component interconnect) Express, or AGP (accelerated graphics port) interface to couple with a graphics controller 341 which, in turn provides graphics and possible audio to a display 337. The PCI Express interface may also be used to couple to other high speed devices. In the example of FIG. 3, six×4 PCI Express lanes are shown. Two lanes connect to a TCP/IP (Transmission Control Protocol/Internet Protocol) Offload Engine 317 which may connect to network or TCP/IP devices such as a Gigabit Ethernet controller 339. Two lanes connect to an I/O Processor node 319 which can support storage devices 321 using SCSI (Small Computer System Interface), RAID (Redundant Array of Independent Disks) or other interfaces. Two more lanes connect to a PCI translator hub 323 which may support interfaces to connect PCI-X 325 and PCI 327 devices. The PCI Express interface may support more or fewer devices than are shown here. In addition, while PCI Express and AGP are described, the MCH may be adapted to support other protocols and interfaces instead of, or in addition to those described.

The ICH 365 offers possible connectivity to a wide range of different devices. Well-established conventions and protocols may be used for these connections. The connections may include a LAN (Local Area Network) port 369, a USB hub 371, and a local BIOS (Basic Input/Output System) flash memory 373. A SIO (Super Input/Output) port 375 may provide connectivity a keyboard, a mouse, and other I/O devices. The ICH may also provide an IDE (Integrated Device Electronics) bus or SATA (serial advanced technology attachment) bus for connections to disk drives 387, or other large memory devices.

The particular nature of any attached devices may be adapted to the intended use of the device. Any one or more of the devices, buses, or interconnects may be eliminated from this system and others may be added. For example, video may be provided on a PCI bus, on an AGP bus, through the PCI Express bus or through an integrated graphics portion of the host controller.

A lesser or more equipped optimization, process flow, or computer system than the examples described above may be preferred for certain implementations. Therefore, the configuration and ordering of the examples provided above may vary from implementation to implementation depending upon numerous factors, such as the hardware application, price constraints, performance requirements, technological improvements, or other circumstances. Embodiments of the present invention may also be adapted to other types of data flow and software languages than the examples described herein.

Embodiments of the present invention may be provided as a computer program product which may include a machine-readable medium having stored thereon instructions which may be used to program a general purpose computer, mode distribution logic, memory controller or other electronic devices to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other types of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. A method comprising:
parsing a code sequence into an internal representation of the sequence;
finding an input channel in the internal representation;
finding a put to the input channel in the internal representation;
finding a get to the input channel in the internal representation;
replacing the input channel with a temporary variable;
replacing the put with a first function call to the temporary variable; and
replacing the get with a second function call to the temporary variable.

2. The method of claim 1, wherein the put is from an actor, the method further comprising checking the internal representation for additional channel puts from the actor and replacing the input channel, the get and the put only if no additional channel puts from the actor are found.

3. The method of claim 1, wherein the put is from an actor, the method further comprising checking the internal representation for additional channel puts from another actor to the channel and replacing the input channel, the get and the put only if no additional puts to the channel from another actor are found.

4. The method of claim 1, wherein the channel get is from an actor, the method further comprising checking the internal representation for additional temporary variable assignments from the actor and replacing the input channel, the get, and the put only if no additional temporary variable assignments from the actor are found.

5. The method of claim 1, wherein the channel comprises a queue of a multiple thread process.

6. The method of claim 1, wherein the channel passes messages from one actor to another using puts and gets.

7. The method of claim 6, wherein the actors are processing cores of a microprocessor.

8. The method of claim 1, wherein the internal representation comprises a partially compiled version of the code sequence.

9. The method of claim 1, wherein the put to the input channel comprises a push to an input port and wherein the get to the input channel comprises a push to an output port.

10. The method of claim 1, wherein the first function call comprises an assignment to the temporary variable and the second function call comprises an assignment from the temporary variable.

11. The method of claim 1, wherein the second function call comprises a call to a source actor's service function.

12. A computer system comprising:
a memory:
a bus coupled to the memory; and
a processor coupled to the bus, the processor using the memory to perform operations comprising:
parsing a code sequence into an internal representation of the sequence;
finding an input channel in the internal representation;
finding a put to the input channel in the internal representation;
finding a get to the input channel in the internal representation;
replacing the input channel with a temporary variable;
replacing the put with a first function call to the temporary variable; and
replacing the get with a second function call to the temporary variable.

13. The system of claim 12, wherein the channel passes messages from one actor to another using puts and gets.

14. The system of claim 12, wherein the put to the input channel comprises a push to an input port and wherein the get to the input channel comprises a push to an output port.

15. The system of claim 12, wherein the first function call comprises an assignment to the temporary variable and the second function call comprises an assignment from the temporary variable.

16. The system of claim 12, wherein the second function call comprises a call to a source actor's service function.

17. A machine-readable medium containing instructions, which when operated on by the machine, cause the machine to perform operations comprising:
parsing a code sequence into an internal representation of the sequence;
finding an input channel in the internal representation;
finding a put to the input channel in the internal representation;
finding a get to the input channel in the internal representation;
replacing the input channel with a temporary variable;
replacing the put with a first function call to the temporary variable; and
replacing the get with a second function call to the temporary variable.

18. The medium of claim 17, wherein the put is from an actor, the medium further comprising instructions for checking the internal representation for additional channel puts from the actor and replacing the input channel, the get and the put only if no additional channel puts from the actor are found.

19. The medium of claim 17, wherein the put is from an actor, the medium further comprising instructions for checking the internal representation for additional channel puts from another actor to the channel and replacing the input channel, the get and the put only if no additional puts to the channel from another actor are found.

20. The medium of claim 17, wherein the channel get is from an actor, the medium further comprising instructions for checking the internal representation for additional temporary variable assignments from the actor and replacing the input channel, the get, and the put only if no additional temporary variable assignments from the actor are found.
